(19) United States
(12) Patent Application Publication
(10) Pub. No.: US 2014/0049014 A1
(43) Pub. Date: Feb. 20, 2014

(54) HOSPITAL CART

(71) Applicants: Helmut SCHUMACHER, Coesfeld (DE); Egbert FLUECK, Raesfeld (DE); Carsten EGGEMANN, Duelmen (DE)

(72) Inventors: Helmut SCHUMACHER, Coesfeld (DE); Egbert FLUECK, Raesfeld (DE); Carsten EGGEMANN, Duelmen (DE)

(21) Appl. No.: 13/673,051

(22) Filed: Nov. 9, 2012

(30) Foreign Application Priority Data
Nov. 16, 2011 (DE) 102011055413.0

(51) Int. Cl. A61G 12/00; B62B 3/00

(52) U.S. Cl. CPC A61G 12/00; B62B 3/005
USPC 280/47.35

(57) ABSTRACT

The invention relates to a cart, in particular for transporting sterile goods, with an undercarriage (1) and a housing (2) on the undercarriage (1) having a rear wall (3), two side walls (4) and a front side (5) closed by a single-leaf or double-leaf door. The transport cart is equipped with at least one height-adjustable shelf (6) supported on connectors (7) that are attached to vertical rails (8 and 9) inside the housing (2) and extend parallel to the side walls (4) of the housing (2). The connectors (7) are suspension connectors having one end that can be hung in slots (10) of a front rail (8) on the front (5) of the housing and another end in slots (10) of a rear rail (9) adjacent the housing rear wall (4). The slots (10) of the front rail (8) and the slots of the rear rail (9) adjacent the housing rear wall are in flanges (11 and 12) of the vertical rails (8 and 9), which extend orthogonally to one another.

The invention relates to a cart, in particular for transporting sterile goods, with an undercarriage, a housing on the undercarriage and having a rear wall as well, two side walls, and a front side closed by a single-leaf or double-leaf door, and with at least one height-adjustable shelf. The shelf is supported on connectors that extend parallel to the side walls of the housing and are attached to vertical rails inside the housing. The transport cart can be used in sterile and nonsterile hospital areas for the safe and thus hygienic transport of sterile goods. The shelf is frequently made of a wire rack or a perforated plate. Different embodiments of the shelf permit the transport and storage of sterile goods in baskets, mesh trays, containers, sterile film packaging and disposable packaging.

In the case of a prior-art transport cart from which the invention starts, the vertical rails are formed by posts carrying projecting pins. The connectors for supporting a rack or other shelf have at their ends angled tabs, one of which has a bore and the other of which a C-shaped perforation. The connectors are each pushed at their one end onto a projecting pin of one of the posts and at their other end are hung on a projecting pin. The stability of the suspension still needs improvement. Furthermore, there is the danger of paper packaging or film packaging of the sterile goods being damaged on the projecting pins of the posts.

DE 101 56 602 discloses a cart, in particular for transporting sterile goods, with vertical support members. The support members are formed with preferably equidistant cutouts in which support brackets can be hung on which transport containers can be arranged. The cutouts are according to the drawings on the front on the front vertical support members as well as on the rear vertical support members.

A further cart, in particular for transporting sterile goods, is described in DE 101 55 515. All of the parts of the frame, including the vertical support members, are profiles open at least on one side. To directly receive insert elements, these support members are formed with cutouts that are preferably on the inside legs of the profile.

U.S. Pat. No. 3,199,683 discloses a transport cart with vertical posts. Slots for receiving slide rails are provided on respectively two parallel inner surfaces of adjacent posts, on is which slide rails sheets, pans and the like can be supported.

The object of the invention is to disclose a transport cart for sterile goods, the shelves of which for the sterile goods are adjustable in height without tools in a predetermined grid. The position, number and the type of the shelves should be changeable and replaceable at any time. Projecting parts on which film packaging or paper packaging of the sterile goods can be damaged are to be avoided thereby on the vertical rails as well as on the connectors for supporting the shelves.

The object of the invention and how this object is attained in a transport cart is seen in claim 1.

According to the invention the connectors are suspension connectors that have one end that can be hung in slots of a vertical rail on the front of the housing and another end in slots of a vertical rail adjacent the housing rear wall. According to the invention the slots of the front vertical rail and the slots of the vertical rail adjacent the housing rear wall are in respective flanges of the vertical rails that extend orthogonally to one another. The flange of one vertical rail thus extends parallel to the rear wall, while the flange of the other vertical rail extends parallel to the side wall of the housing. The slots of the vertical rails extend in particular vertically and are preferably at a uniform spacing selected between 50 mm and 70 mm. Particularly preferred is a spacing of about 60 mm.

According to a preferred embodiment of the invention, the flange of the front rail extends parallel to the side wall of the housing. The side walls of the housing can have on the front a U-section profile unitarily formed with the front rail. The slots in the flange of the front rail parallel to the side wall establish the correct position of the connector and secure the connector against axial displacement.

No special tolerance demands are made on the distance that must be maintained during manufacture of the housing between the flange of the front rail and the vertical rails on the rear wall. The suspension connectors are supported in the slots of the rear vertical rail in a floating manner. The plug-in elements inserted in slots of the rear vertical rails give the suspension connectors lateral support and absorb transverse forces.

The flange of the vertical rail adjacent the rear wall of the housing is spaced forward of the rear wall by a spacing dimensioned such that the parts of the suspension connector passing through the slot can project sufficiently far. The rear vertical rail can thereby be an L-profile that is attached to the rear wall, to a side wall or to a strip bridging the housing corner.

Preferably, the suspension connectors are parts stamped and bent of sheet metal and have at their ends connection lugs that can be inserted into the slots of the vertical rails. Assembly is possible without tools. The suspension connectors have at one end an L-shaped connection lug provided with an insert slot that fits over the lower edge of the slots in the respective vertical rail. The connection lug can be inserted into the slots of the flange that extends parallel to the side wall of the housing. Usually, this is the front rail. At their other end the suspension connectors have a connection lug that extends parallel to the side is wall of the housing and can be inserted into the slots of the rear vertical rail whose flange extends parallel to the rear wall of the housing. The connection lug of the suspension connector has a width conforming to the length of the slots. The connection lug inserted into a slot of the rear suspension rail absorbs transverse forces and bending moments acting on the suspension connector and secures the suspension connector vertically.

To absorb large transverse forces and tilting moments an embodiment of the suspension connector has two connection lugs that extend parallel to the side wall and can be inserted into slots spaced apart from one another of the rear vertical rails of the housing. While one of the two connection lugs has a width conforming to the length of the slots, the other connection lug is preferably much narrower.

With all of the embodiments previously described the thickness of the sheet metal of the connection lugs is preferably coordinated with the gap width of the slots provided in the vertical rails such that the connection lugs are in the slots with a lateral play of less than 0.5 mm. A play of 0.1 to 0.3 mm is preferred. Assembly is easy despite the narrow tolerances. First, the suspension connector is pushed into at least one slot of a vertical rail on the rear wall of the housing. Thereafter the suspension rail can be hung by a side-to-side movement in a slot of the front rail. The dimensions and material thickness of the connection lugs and the geometry of the slots can be coordinated with one another with narrow tolerances, without the assembly operation being rendered difficult. The suspension connector can be attached firmly and with a tight fit to the vertical rails of narrow tolerances between the connection lugs and the geometry of the slots.

The geometry of the suspension connectors and their support surfaces are coordinated with the shelf. The suspension connectors can have in particular a center retaining section set back toward the side wall with a support surface for the shelf and end sections offset parallel thereto. A shelf hung in the retaining section, for example a wire rack, a perforated sheet, a basket, or the like, is secured in position by the end sections of the suspension connector projecting into the housing.

For dimensional stability, the suspension connectors can have a chamfer on their lower edge.

The shelf supported on the suspension connectors can be made in a variety of ways. The shelf can be embodied in particular as a wire rack, as a flat surface, dish or as a basket, wherein depending on the embodiment the shelf is hung on the suspension connectors or can bear on projecting surfaces of the suspension connectors.

The transport cart according to the invention can also be equipped with one or more extensible shelves, which like all other shelves can be adjusted variably and without tools in the predetermined height grid of the vertical rails. For an extensible shelf, suspension connectors are used on which respective slide rails are attached. The shelf has side parts that are guided in a displaceable manner on the slide rails between stop elements.

Preferably, the slide rails are plastic strips and profiles are connected to the side parts of the shelf or made unitarily of sheet metal and are U-shaped to grip around the slide rails. Stops attached under the slide rails limit the slide travel of the shelf. In order to place sterile goods on the shelves or to remove them from the shelf, the shelf can be drawn out of the housing of the transport cart by up to one third. With a standard housing depth of 600 mm, the shelf thus can project forward about 200 m out of the cart. This facilitates handling considerably. The shelf preferably has a frame formed of side parts and cross members. The shelf surface can be composed of a wire rack, a perforated sheet or the like.

The transport cart according to the invention can be used as a closed sterile goods transport cart whose housing is produced from a stable self-supporting body of stainless steel. On its front the cart has a single-leaf or double-leaf door that can be pivoted through an angle of up to 270°. With a predetermined spacing, which is predetermined by the arrangement of the slots of the vertical rails, wire rack shelves, closed shelves and other shelves from a standard shelving program can be used. The shelves can be hung in the suspension connectors and removed again therefrom simply and quickly. The interior of the transport cart is smooth and can therefore be cleaned easily. By moving the suspension connectors, the shelves can be offset variably in a predetermined array determined by the arrangement of the slots of the vertical rails. The position, number as well as the type of shelf can thereby be changed and replaced at any time. In particular the transport cart can also be equipped with one or more extensible shelves.

The invention is explained below based on illustrated embodiments. Therein:

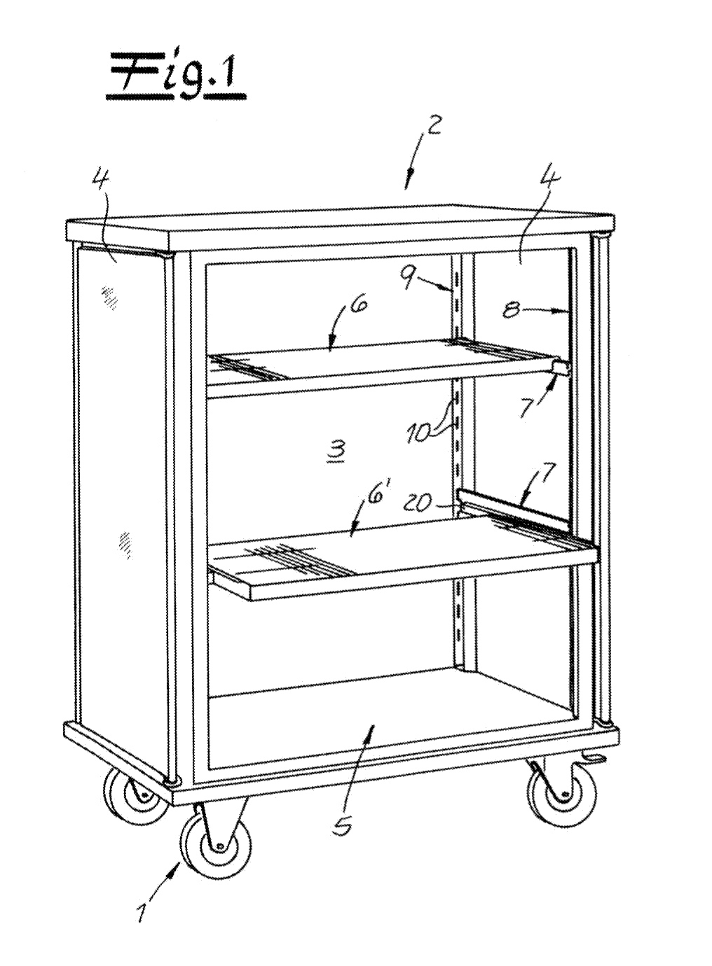

FIG. 1 shows an open transport cart for sterile goods with two height-adjustable shelves,

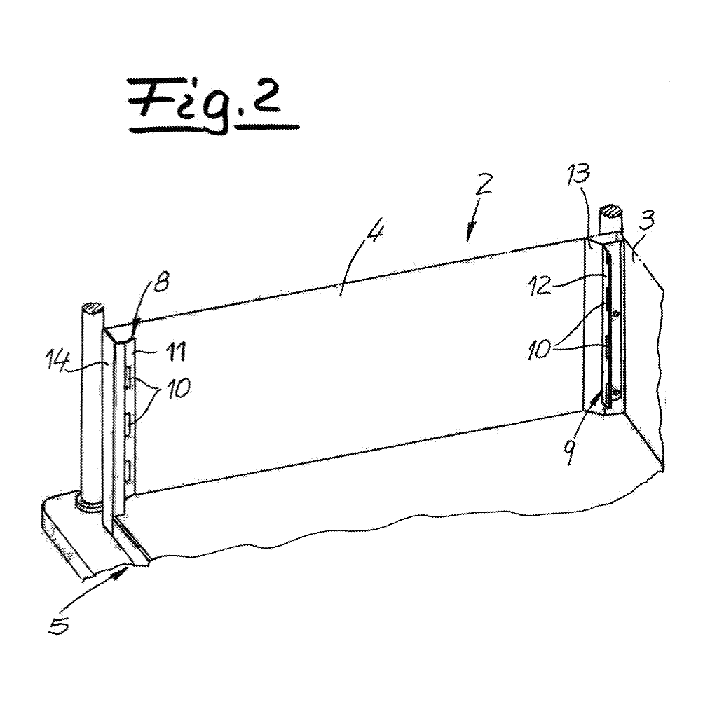

FIG. 2 a detail view of the interior of the transport cart shown in FIG. 1,

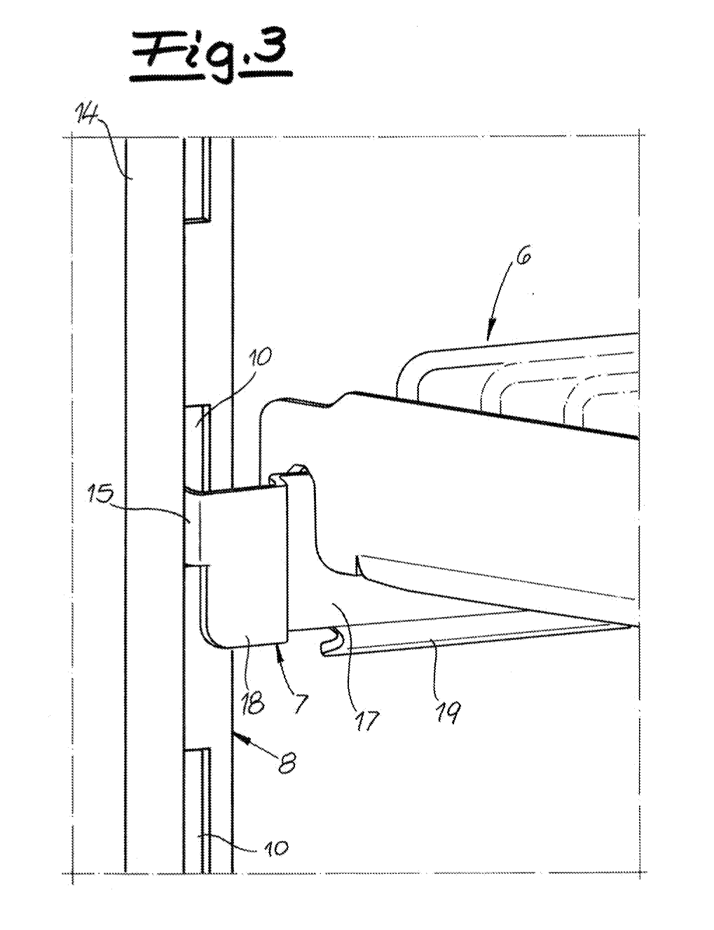

FIG. 3 shows the attachment of a suspension connector to the front of the transport cart shown in FIG. 1,

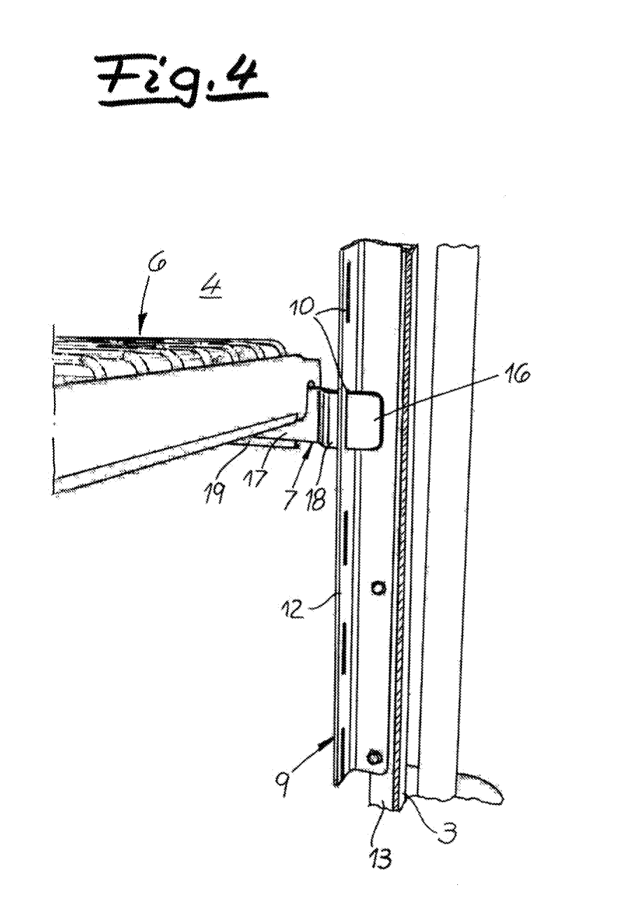

FIG. 4 shows the attachment of a suspension connector to the rear wall of the transport cart shown in FIGS. 1,

FIG. 5 is a view from below of a suspension connector for a displaceable shelf,

FIG. 6 shows the attachment of the suspension connector shown in FIG. 5 to the rear wall of the transport cart,

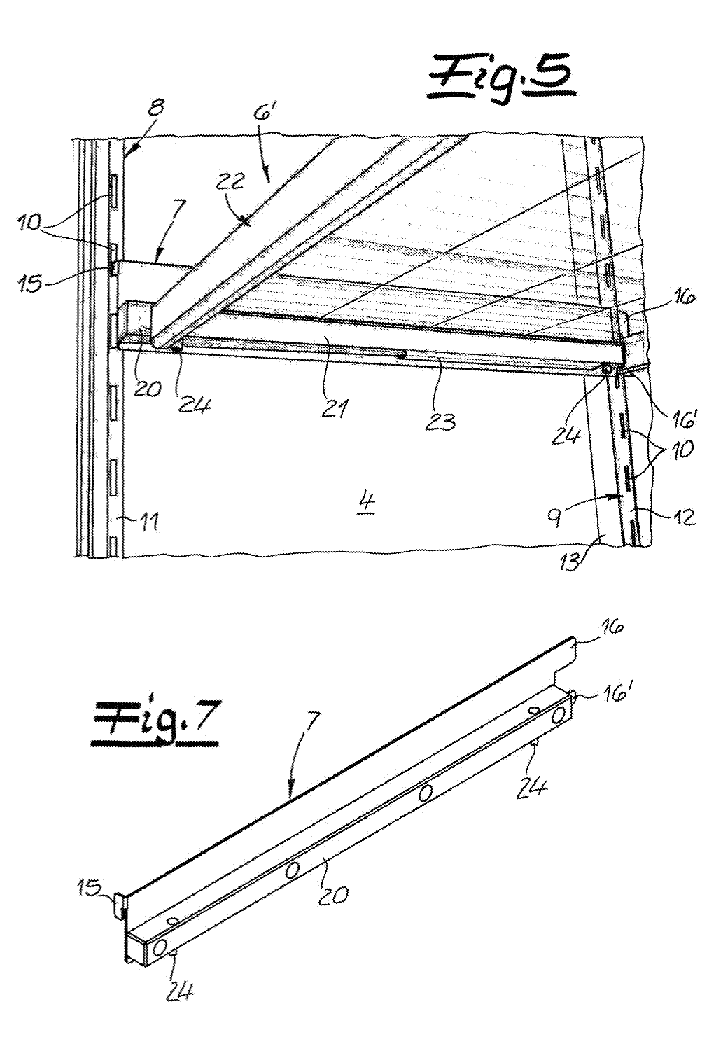

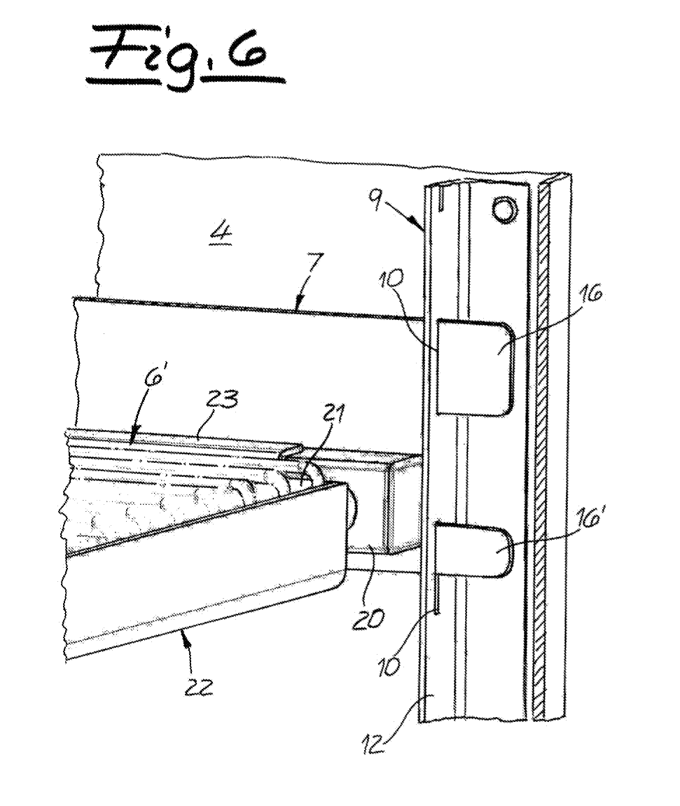

FIG. 7 is a detail view of the suspension connector shown in FIGS. 5 and 6.

FIG. 1 shows a sterile-goods transport cart that can be used in sterile and nonsterile hospital areas for the safe and hygienically troublefree transport of sterile goods, namely for bringing in as well as for taking out. The transport cart is basically formed of an undercarriage 1 carrying a box-shaped housing 2 that has a rear wall 3 as well as two side walls 4 and a front side 5 closed by a single-leaf or double-leaf door. FIG. 1 shows the transport cart without doors. The transport cart is equipped with one or more height-adjustable shelves 6 and 6′. The shelves 6 and 6′ are supported on connectors 7 attached to vertical rails 8 and 9 inside the housing 2 and extending parallel to the side walls 4 of the housing 2.

FIG. 2 shows in section an interior view of the housing 2, namely toward view toward the left side wall 4 of the transport cart. The vertical rails 8 and 9 have vertically aligned slots 10, at a uniform spacing between 50 mm and 70 mm. A spacing of about 60 mm is preferred. The slots 10 of the front rail 8 and the slots of the respective rear rail 9 adjacent the housing rear wall are in flanges 11 and 12 extending perpendicular to each other. According to the view of FIG. 2, the flange 11 of the front rail 8 extends parallel to the plane of the side wall 4 of the housing 2, while the flange 12 of the rear rail 9 adjacent the rear wall 3 of the housing 2 is spaced forward of the rear wall 3 and extends parallel to the plane of the rear wall 3. The rear rear rail 9 is of L-section and is attached to a strip 13 bridging the respective housing corner. Alternatively, the L-profile can also be attached directly to the rear wall 3 or to the side wall 4. The side wall 4 of the housing 2 has on the front side a U-section edge profile 14. The free leg of the edge profile 14 can be used at the same time as a front rail. The slotted flange 11 is formed unitarily in one piece with the edge profile 14. Alternatively, of course it is also possible to make the front rail 8 as a separate L-profile and to attach it to the edge profile 14.

The connectors 7 that support the shelf 6 are formed as suspension connectors that can be hung without tools in the vertical rails 8 and 9. FIGS. 3 and 4 show the attachment of a suspension connector to the front rail 8 and to the rear rail 9 adjacent the rear wall. The suspension connector 7 is a part stamped and bent from sheet metal and has on its ends connection lugs 15 and 16 that can be inserted into the slots 10 of the vertical rails 8 and 9. FIG. 3 shows the attachment of the suspension connector 7 to the front rail 8. On the assigned end the suspension connector 7 has an L-shaped lug 15 and that is provided with an insertion slot that can be fitted over the lower edge of the slot 10 of the front rail. On its other end, the suspension connector 7 has a connection lug 16 that extends parallel to the side wall 4 of the housing 2 and has a width conforming to the length of the slots 10 (FIG. 4). The sheet metal thickness of the connection lugs 15 and 16 also conforms to the width of the slots 10 provided in the vertical rails 8 and 9 such that the connection lugs 15 and 16 fit in the slots 10 with a lateral play of less than 0.5 mm, preferably with a play between 0.1 mm and 0.3 mm. A snug fit of the suspension connector 7 to the vertical rails 8 and 9 is thus ensured.

It can also be seen from the views of FIGS. 3 and 4 that the suspension connector 7 has a center retaining section 17 set back toward the side wall 4 with a support surface for the shelf 6 and end sections 18 offset forward parallel to the retaining section 17. The shelf 6, here a wire rack shelf, can be hung on the suspension connector 7. To improve dimensional stability, the suspension connector 7 furthermore has a chamfer 19 on its lower edge. In the illustrated embodiment the shelf 6 is a wire rack. The shelf can also be a closed shelf with a flat surface, a pan, or a basket.

The transport cart shown in FIG. 1 is equipped, for example, with a fixedly hung wire rack shelf 6 and an extendable wire rack shelf 6′. The extendable wire rack shelf 6′ can be drawn out by a third. With a depth of about 600 mm, the shelf thus can project forward about 200 mm out of the cart. A suspension connector 7 for an extendable shelf 6′ is shown in FIGS. 5 through 7. The suspension connector 7 is produced as a stamped and bent sheet-metal part and has on its ends connection lugs 15 and 16 that can be inserted into the slots 10 of the rails 8 and 9. A slide rail carried on the suspension connector 7 is preferably made of a plastic strip, for example of polyethylene. The shelf 6′ has a frame 22 formed by side parts 21 and cross members. U-shaped profiles 23 on the side parts 21 engage around the slide rails 20 so that the side part 21 is guided as a carriage on the slide rail 20. The profile 23 can be made in one piece with the side part 21 and be composed of a section of the side parts formed of sheet metal. On the underside of the slide rail 20 are stop pins 24 that limit the slide travel of the shelf 6′.

The suspension connector 7 has on its front end an L-shaped connection lug 15 that is provided with an insert slot and that can be hung in slots 10 of the rear rail 9. On its other end the suspension connector 7 has two connection lugs 16 and 16′ that extend parallel to the side wall 4 and that can be inserted into slots 10 spaced apart from one another of the front rail 8. One of the two connection lugs 16 has a width conforming to the length of the slots 10, while the other connection lug 16′ is much narrower.

The suspension connector 7 is able to absorb large transverse forces and tilting moments, which can occur during a loading of the extended shelf 6′.

1. A cart comprising:
an undercarriage,
a housing on the undercarriage and having a rear wall, two side walls, and a front side closable by a single-leaf or double-leaf door,
at least one height-adjustable shelf,
front and rear vertical rails inside the housing and extending parallel to the side walls of the housing
suspension connectors having one end that can be hung in slots of a front rail on the front of the housing and another end in slots of a rear rail adjacent the housing real wall, the slots of the front rail and the slots of the rear rail adjacent the housing rear wall being formed in flanges of the front and rear vertical rails that extend orthogonally to one another.

2. The transport cart according to claim 1, wherein the slots of the vertical rails extend vertically.

3. The transport cart according to claim 1, wherein the flanges of the front rails extend parallel to the respective side walls of the housing.

4. The transport cart according to claim 3, wherein the side walls of the housing have on the front side a U-section edge profile, and that the respective flange is formed in one piece with the edge profile.

5. The transport cart according to claim 1, wherein the flange of the rear rail adjacent the rear wall of the housing is spaced forward of the rear wall.

6. The transport cart according to claim 5, wherein the rear rail is of L-section and is attached to the rear wall, to a side wall or to a strip bridging the housing corner.

7. The transport cart according to claim 1, wherein the suspension connectors are parts stamped and bent from sheet metal and have at their ends connection lugs that can be inserted into the slots of the vertical rails without tools.

8. The transport cart according to claim 7, wherein the suspension connectors have at one end an L-shaped connection lug provided with an insert slot that can fit over the lower edge of the slots in the vertical front rails.

9. The transport cart according to claim 8, wherein the suspension connectors have on their other end a connection lug that extends parallel to the side wall of the housing and has a width conforming to the length of the respective slots.

10. The transport cart according to claim 8, wherein the suspension connectors at their other end have two connection lugs that extend parallel to the side wall and that can be inserted into slots spaced apart from one another of the rear rail.

11. The transport cart according to claim 10, wherein one of the two connection lugs has a width conforming to the length of the slots and the other connection lug is narrower.

12. The transport cart according to claim 7, wherein a thickness of the sheet metal of the connection lugs is coordinated with the gap width of the slots provided in the vertical rails such that the connection lugs fit in the slots with a lateral play of less than 0.5 mm.

13. The transport cart according to claim 1, wherein the slots in the vertical rails a have a uniform spacing between 50 mm and 70 mm.

14. The transport cart according to claim 1, wherein the suspension connectors have a center retaining section set back toward the side wall with a support surface for the shelf and end sections offset parallel to the retaining section.

15. The transport cart according to claim 1, wherein the suspension connectors have a chamfer on their lower edge to improve dimensional stability.

16. The transport cart according to claim 1, wherein the shelf is a wire rack, a flat surface, a pan, or a basket, and is hung on the suspension connectors or bears on projecting surfaces of the suspension connectors.

17. The transport cart according to claim 1, wherein a slide rail is attached to the suspension connectors and that the shelf has side parts that are guided in a displaceable manner on the slide rails between stop elements.

18. The transport cart according to claim 17, wherein the slide rails are plastic strips and that profiles connected to or shaped on the side parts grip the slide rails in a U-shaped manner.

19. The transport cart according to claim 18, wherein stop pine are attached under the slide rails and limit slide travel of the shelf.

20. The transport cart according to claim 17, wherein the shelf has a frame formed of the side parts and cross members.
